(19) United States
(12) Patent Application Publication
(10) Pub. No.: US 2018/0027727 A1
(43) Pub. Date: Feb. 1, 2018

(54) DEVICE FOR DISCHARGING LIQUIDS, AND METHOD FOR CONTROLLING THE MOVEMENT OF AT LEAST TWO EXTENSION ARMS OF AN AGRICULTURAL FIELD SPRAYER

(71) Applicant: Horsch Leeb Application Systems GmbH, Oberpöring (DE)

(72) Inventor: Theodor Leeb, Wallersdorf (OT Ettling) (DE)

(73) Assignee: Horsch Leeb Application Systems GmbH, Oberpöring (DE)

(21) Appl. No.: 15/550,449

(22) PCT Filed: Feb. 15, 2016
(86) PCT No.: PCT/EP2016/053158

§ 371 Date: Aug. 11, 2017

(30) Foreign Application Priority Data
Feb. 13, 2015 (DE) 10 2015 102 080.7

(51) Int. Cl. A01C 23/04

(52) U.S. Cl. CPC A01C 23/047; A01B 69/001

(57) ABSTRACT

A device for spreading liquids in an agricultural field includes at least two cantilever arms, each having multiple means for distributing the liquid. The two cantilever arms are pivotable about one or more axes running approximately parallel to a driving direction of the device, and each arm includes one or more attached actuators that transmit an actuating force to produce a pivoting movement onto the cantilever arms. First sensors for determining a relative actual spacing of the cantilever arms and second sensors for detecting an environmental profile provide signals to a control apparatus which controls the actuators to achieve a desired movement and spacing of the cantilever arms. An associated method is also described.

### CROSS-REFERENCE TO RELATED APPLICATION

This application claims priority from German Patent Application No. 102015102080.7 filed Feb. 13, 2015, the disclosure of which is hereby incorporated herein in its entirety by reference.

### FIELD OF THE INVENTION

The present invention relates to a device for spreading liquids as well as to a method for controlling the movement of at least two cantilever arms of an agricultural field sprayer.

### BACKGROUND

Field sprayers and spray booms hitched to work machines, such as tractors, in some cases have very large working widths of more than 20 meters. Such wide spray booms are folded and collapsed in for transport purposes. In the field, symmetrical cantilevered arms of several meters length are located on both sides of the work machine, with the cantilevered arms having a varying spacing from the ground according to surface conditions and field relief.

Also known are such devices in which the particular spacing of the cantilever arms to the ground surface is sensor-detected. Based on the sensor detection, the cantilever arms can then be pivoted in order to be able to ensure an as far as possible constant or homogeneous spacing of the cantilever arms to the ground surface. In practice, it has been shown that such regulating measures can involve problems with regard to obstacles existing in the working area. The cantilever arms can inadvertently dip toward the ground surface if there are crop gaps in the working area. Devices and methods for the autonomous pivoting of cantilever arms to prevent collisions with obstacles, if these should occur in the working area, would additionally be desirable.

It is already known to use scanner units for identifying a surrounding, at least in driving direction, of vehicles being employed for agricultural purposes in order to be able to identify obstacles in the working area sufficiently early. Such a system is disclosed in GB 2521343 A. For this object, a scanner unit is positioned on the roof of a self-propelled vehicle such that the surrounding preceding the vehicle can be detected. Based on the detected surrounding, the height of the cantilevers can be adjusted by means of a corresponding control device and adjustment elements.

A similar object is disclosed in EP 2 944 171 A1. A laser unit for detecting the surrounding preceding in driving direction across the entire working width can also be associated with the agricultural machine described there. Based on the detected data, the cantilevers can be adapted to the crop height by means of a control device and adjustment elements.

### SUMMARY OF THE INVENTION

For this reason, one object of the invention can be seen in providing a corresponding device and a corresponding method that have an improved alignment of cantilever arms, in particular in the instance of crop gaps or of obstacles protruding above the crop. By means of the device and by means of the method, it is furthermore intended to reduce the risk of damaging the cantilever arms during a working process.

The above objects are fulfilled by a device and a method comprising the features in the claims for protection 1 and 8. Further advantageous embodiments of the invention are described in the subclaims.

The invention relates to a device for spreading liquids, such as fertilizers or the like. The device has at least two cantilever arms, each with a plurality of means for distributing the liquid, which at least two cantilever arms are pivotable about one or more axes running approximately parallel to a driving direction of the device. For example, two or more cantilever arms can be provided that are pivotable independently of each other, each about their particular axis. It is also conceivable for the at least two cantilever arms to be mechanically coupled with each other or to be mechanically connected to each other and to be in each case synchronously pivoted about a common axis. Where appropriate, the at least two cantilever arms can be a continuous boom linkage system, which is rotated about a horizontal axis, for pivoting the at least two cantilever arms. The horizontal axis can be oriented approximately in the center of the boom linkage and parallel to the driving direction. It is also possible that one or more cantilever arms are formed by a plurality of segments or that they comprise a plurality of segments that can be pivoted relative to each other, as the case may be, about their particular axes running parallel to the driving direction of the device. In particular, the boom linkage as it is used in the present invention, as the case may be, can be formed according to EP 2 186 405 A1. The disclosure of the EP patent application is therefore intended to be incorporated by reference in the present description.

The device moreover comprises one or more actuators that are connected to the at least two cantilever arms and that can transmit an actuating force for a pivoting movement onto the at least two cantilever arms.

The device according to the invention in addition comprises one or more first sensors by means of which a relative actual spacing of the at least two cantilever arms to a ground-side crop to be treated and/or a relative tilt position of the at least two cantilever arms can be determined. The one or more first sensors can be arranged on the at least two cantilever arms. As will be described below, it is for example conceivable that the one or more first sensors are formed by ultrasonic sensors. It is also possible that the one or more first sensors are formed by angle sensors or, as the case may be, by angle potentiometers, which can determine the relative tilt position of the at least two cantilever arms in relation to a horizontal or, as the case may be, in relation to a middle part to which the cantilever arms are attached. The cantilever arms can be attached to the middle part, if applicable, so as to be lowerable and liftable. The angle potentiometers or, as the case may be, the angle sensors can be connected to a control apparatus, where the control apparatus in operative connection with the angle sensors can determine the relative actual spacing of the at least two cantilever arms to a ground-side crop to be treated.

Furthermore provided are one or more second sensors by means of which an environmental profile, at least preceding in driving direction of the device, can be detected. The one or more first sensors and the one or more second sensors are connected to a control apparatus by means of which the one or more actuators are controllable for a defined pivoting movement of the at least two cantilever arms in consideration of the actual spacing and/or the particular relative tilt position measured by the one or more first sensors and of the environmental profile detected by the one or more second sensors.

Furthermore provided are one or more scanners by means of which a surrounding, at least preceding in driving direction, can be scanned and detected across the entire working width. “Across the entire working width” is intended to mean that the one or more scanners can detect a range of approximately 20 meters to the left and to the right as well as a range of approximately 15 meters to the front. The one or more scanners are preferably positioned on the roof of the self-propelled vehicle or, as the case may be, of the towing vehicle; they can, however, also be arranged in any other location on the self-propelled vehicle or on the towing vehicle. On the basis of the determined data, it is possible to generate a surface model in the form of a terrain relief, whereby at least the surrounding lying ahead in driving direction, including crop gaps, driving lanes, obstacles or other irregularities, is depicted. Algorithms are used for detecting irregularities in the surface model. The one or more scanners can moreover be connected to a control device by means of which the at least two cantilever arms can be preset based on the generated surface model. It is thus possible to adjust the device such that a resulting control deviation is as small as possible, that is to say, the linkage middle part, the tilt angle in slope compensation, or the angle between the segments of the wings can be adjusted relative to the surface model. The measured values of the one or more first sensors serve merely for monitoring purposes, and they can be overridden or ignored. Overriding of the monitoring values will be carried out if the one or more scanners detect and assess irregularities, such as a crop gap, in the preceding surrounding. The driver no longer has to actively intervene; instead, the device is automatically controlled across this area. For the defined pivoting of the at least two cantilever arms, at least two control loop systems exist side by side, which control loop systems are in each case continuously reconciled with each other during ongoing operation. The at least two control systems are composed of the control loop of the one or more scanners and of the control loop of the first and/or of the second sensors. The laser scanner detects the crop ahead of the vehicle whereas the first sensors, in particular the ultrasonic sensors, measure the spacing between device and crop. The theoretical spacing between device and crop can thus be determined from the detected crop outline and the present position of the boom linkage. If these two values deviate from one another, the difference between these values has to be reconciled.

In particularly preferred embodiments, the one or more first sensors comprise at least one ultrasonic sensor. Furthermore, the one or more second sensors comprise at least one laser sensor. The one or more second sensors can be arranged directly on one or more of the at least two cantilever arms and/or on a towing vehicle. Furthermore, the one or more actuators can be formed by one or more hydraulic cylinders. The one or more scanners can be associated with the self-propelled vehicle or, as the case may be, with the towing vehicle. Preferably, the one or more scanners are positioned on the roof of the self-propelled vehicle or, as the case may be, of the towing vehicle. The one or more scanners can, however, also be positioned in any other location on the self-propelled vehicle or the like. The one or more scanners preferably comprise at least one laser scanner.

The invention moreover relates to a method for controlling the movement of at least two cantilever arms of an agricultural field sprayer. According to the method, the surrounding, at least preceding the field sprayer in driving direction, is scanned and detected across the entire working width. In this context, the measuring beam can be laterally deflected, whereby many measurement points on a line ahead of the vehicle are detected. A surface model is generated based on the detected data, which surface model depicts the terrain relief including crop gaps, driving lanes, obstacles, or other irregularities. Obstacles, for example, are distinguished in the measured data in such a form that they protrude from the detected crop outline. Algorithms, which search for and assess obstacles, for example, or crop gaps in the crop outline or, as the case may be, in the generated surface model, are used for detecting irregularities in the surface model. Subsequently, the field sprayer can be preset based on the generated surface model. It is thus possible to adjust the device such that the resulting control deviation is as small as possible. In particular, the linkage middle part, the tilt angle in slope compensation, or the angle between the segments of the wings can be adjusted relative to the surface model in the process. It is furthermore possible for a defined pivoting of the at least two cantilever arms to be carried out in consideration of the surrounding preceding the field sprayer in driving direction, for example, in the case of an obstacle. Along with the detection of the obstacles or, as the case may be, of the crop gaps in the field, an assessment is carried out at the same time. Factors such as position and current driving course with the present steering angle and speed, maximum lifting height of the boom linkage, detection of the obstacle or, as the case may be, of the gap by the first and the second sensor, curvature and gradient are taken into account in the context of a corresponding evaluation. The information on the detected irregularities in the crop is transferred to the control.

The defined pivoting of the at least two cantilever arms is subjected to monitoring by way of determining a relative actual spacing of the at least two cantilever arms to a ground-side crop to be treated and/or a relative tilt position of the at least two cantilever arms in relation to a horizontal and by way of detecting an environmental profile, at least preceding the field sprayer in driving direction.

The novel detection of the surrounding leads to a clear reduction of the deviation of the actual value from the desired value in the regulation of the field sprayer. The risk of damages to the field sprayer can be reduced by identifying gaps or obstacles in the crop. In the context of detecting obstacles or crop gaps, the outline is checked for extreme deviations of the height in relation to the middle height, for extreme gradients, and for extreme curvatures. At the same time, optimal weather conditions can be made use of daylight-independently by employing laser scanners for an environmentally friendly application.

In particularly preferred embodiments, the environmental profile preceding the field sprayer in driving direction can be detected by at least one laser sensor. A transmitter of the laser sensor can furthermore emit an at least approximately horizontally oriented laser beam. It can be additionally provided that the relative actual spacing of the at least two cantilever arms to the ground-side crop to be treated is determined by way of a plurality of ultrasonic sensors arranged on the at least two cantilever arms. Furthermore, the defined pivoting of the at least two cantilever arms can be effected by way of one or more hydraulic actuators.

The surrounding preceding the field sprayer in driving direction can moreover be scanned and detected across the entire working width by at least one laser scanner. “Across the entire working width” means that ranges of approximately 20 meters to the left and of approximately 20 meters to the right as well as of approximately 15 meters ahead can be scanned and detected by means of the laser scanner. The laser scanner is then preferably associated with the self-propelled vehicle or, as the case may be, with the towing vehicle. In practice it has proved advantageous to position the laser scanner on the roof of the self-propelled vehicle or, as the case may be, of the towing vehicle.

It is possible by means of the detected data to generate a surface model depicting the terrain relief. In particular, it is possible to map driving lanes or irregularities, such as crop gaps or obstacles.

The generated surface model can be output to a monitor. The monitor is preferably located in the drivers cab such that the generated surface model is available to the driver at all times. Obstacles can likewise be displayed in the context of the surface model. Well casings, posts, or power poles, for example, can be pointed out as obstacles. Such irregularities can be detected by the use of algorithms. Depending on the terrain relief, a warning can be issued to the driver if the assessment predicts a collision with the boom linkage, or regulating of the field sprayer can be initiated.

If the obstacle is a well casing, for example, which protrudes slightly above the crop, regulating of the field sprayer will be initiated. In this instance, the at least two cantilever arms, in particular, are raised by the height of the obstacle. After the obstacle has been passed, the cantilever arms are correspondingly readjusted to the crop height and brought into an angular position and/or a height position that is appropriate for the crop. When regulating the field sprayer in this manner across such an obstacle as, for example, a well casing or the like, it can be advantageous to influence the speed of the vehicle at the same time, thereby preventing that the entire work process of the field sprayer is too strongly affected or even has to be interrupted. A driving speed that is reduced by a reasonable magnitude allows for the field sprayer to be securely raised by the height of the obstacle lying ahead. In this way, and due to such a regulating of the field sprayer, imminent collisions with obstacles can be prevented even more reliably.

The defined pivoting of the at least two cantilever arms is based on a control and a reconciliation of at least two control systems. The at least two control systems are composed of the control loop of the laser scanner and of the control loop of the first sensors, in particular of the ultrasonic sensors. The laser scanner detects the crop ahead of the vehicle whereas the ultrasonic sensors measure the spacing between boom linkage and crop. The theoretical spacing between boom linkage and crop can thus be determined from the detected crop outline and the present position of the boom linkage. If these two values deviate from one another, the difference between these values has to be reconciled.

A warning is issued, in particular, when the laser scanner detects an obstacle protruding particularly high from the crop and identifies a risk of collision therefrom. The lifting height of the field sprayer is not sufficient for such obstacles. Instead, a warning is issued to the driver to alert him to the imminent obstacle. The driver is thus in a position to initiate a braking process in due time or to evade the obstacle. An active braking by the machine or an active evasion by the machine would also be conceivable.

The method moreover provides that the at least two cantilever arms are overridden by means of one or more scanner units based on the generated surface model. The surface model and the generated terrain relief in fact represent the relevant parameters. In particular, the measured values from the ultrasonic sensors are overridden when there is a crop gap in the range of the ultrasonic sensors. The driver no longer has to actively intervene, instead, the device is automatically controlled across this area.

In the following passages, the attached figures further illustrate exemplary embodiments of the invention and their advantages. The size ratios of the individual elements in the figures do not necessarily reflect the real size ratios. It is to be understood that in some instances various aspects of the invention may be shown exaggerated or enlarged in relation to other elements to facilitate an understanding of the invention.

### BRIEF DESCRIPTION OF DRAWINGS

FIG. 1 shows a schematic view of an embodiment of a device according to the invention.

FIG. 2 shows a perspective view of a self-propelled vehicle with a field sprayer.

### DETAILED DESCRIPTION

The same or equivalent elements of the invention are designated by identical reference characters. Furthermore and for the sake of clarity, only the reference characters relevant for describing the figure are provided. It should be understood that the detailed description and specific examples, while indicating a preferred embodiment, are intended for purposes of illustration only and are not intended to limit the scope of the invention.

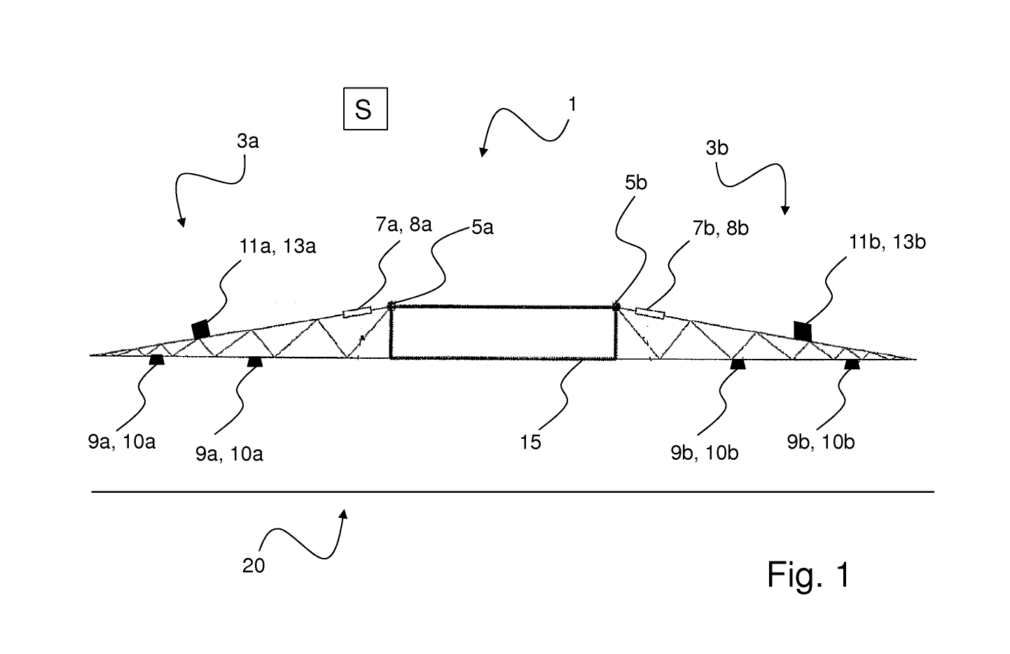

FIG. 1 shows a schematic view of an embodiment of a device 1 according to the invention. The device 1 is intended for spreading fertilizers, and it comprises two cantilever arms 3a and 3b, which are connected to a middle part 15 each by way of a particular pivot axis 5a or, as the case may be, 5b, which is oriented parallel to the driving direction. Each cantilever arm 3a and 3b has an actuator 7a or, as the case may be, 7b associated with it by way of which each particular cantilever arm 3a or, as the case may be, 3b can be pivoted. The actuators 7a or, as the case may be, 7b are designed as hydraulic cylinders 8a or, as the case may be, 8b.

The device 1 furthermore comprises a plurality of first sensors 9a and 9b arranged on the two cantilever arms 3a and 3b, the sensors being designed as ultrasonic sensors 10a and 10b. The first cantilever arm 3a has the ultrasonic sensors 10a associated with it; the second cantilever arm has the ultrasonic sensors 10b associated with it. Each particular relative spacing of the cantilever arms 3a and 3b to the ground surface 20 or rather to the particular crop of the ground surface 20 can be determined by means of the first sensors 9a and 9b or, as the case may be, by means of the ultrasonic sensors 10a and 10b.

Furthermore provided is a plurality of second sensors 11a and 11b by means of which an environmental profile, at least preceding in driving direction of the device 1, can be detected. The second sensors 11a and 11b are designed as laser sensor 13a and 13b, respectively.

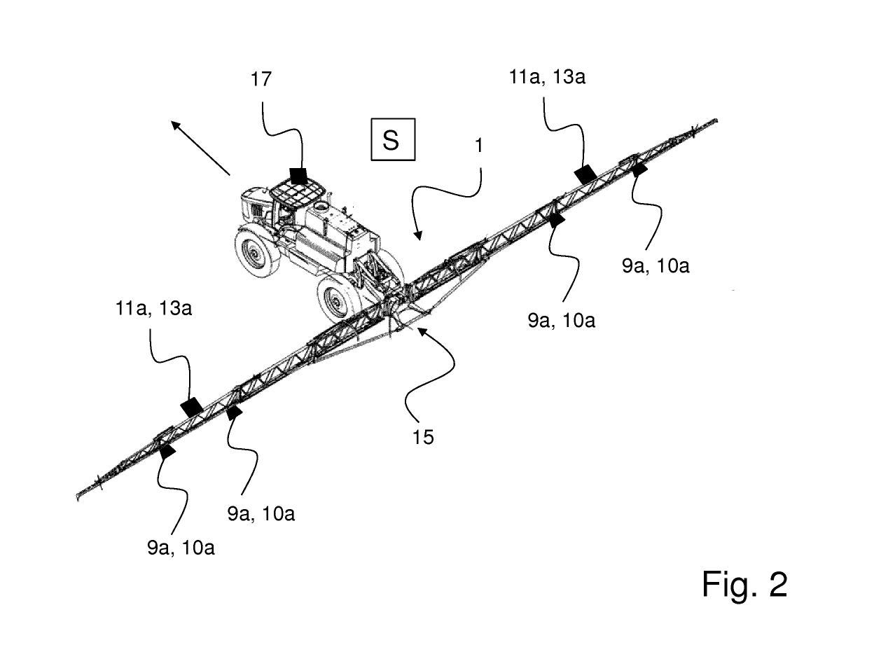

The first sensors 9a and 9b as well as the second sensors 11a and 11b are connected to the control apparatus S. The actuators 7a and 7b can be activated by means of the control apparatus S in consideration of the actual spacing measured by the first sensors 9a and 9b and of the environmental profile detected by the second sensors 11a and 11b in order to pivot the cantilever arms 3a and 3b about their particular axis 5a and 5b, respectively. These values serve merely for monitoring purposes with regard to pivoting the device 1. Regulating the device 1 in fact is carried out now by means of one or more scanners, which are associated with the self-propelled vehicle (see also FIG. 2).

FIG. 2 shows a perspective view of a self-propelled vehicle with a field sprayer. Here, one or more scanners, in the present instance in the form of a laser scanner 17, are associated with the self-propelled vehicle. The laser scanner 17 is preferably located on the roof of the self-propelled vehicle. At least a surrounding preceding the field sprayer in driving direction (indicated by direction of arrow) can be scanned and detected across the entire working width by means of the laser scanner 17. The laser scanner 17 is able to detect ranges that are approximately 20 meters to the left and approximately 20 meters to the right as well as approximately 15 meters ahead in relation the towing vehicle. In total, an angle of approximately 180° can be covered. By means of the data determined by the laser scanner 17, it is possible to create a surface model. The surface model reflects at least the surrounding preceding in driving direction in the form of a terrain relief, including crop gaps, driving lanes, obstacles or other irregularities. The laser scanner 17 is likewise connected to the control device S, by means of which the at least two cantilever arms 3a, 3b are preset based on the generated surface model, that is to say, the middle part 15, the tilt angle in slope compensation, or the angle between the segments of the wings can be adjusted relative to the surface model.

The generated surface model can be output to a monitor. The monitor is preferably located in the drivers cab of the self-propelled vehicle such that the generated surface model is available to the driver at all times. Depending on the terrain relief, a warning can be issued to the driver, or the regulating of the device 1 can be initiated. Irregularities in the crop can be detected by the use of algorithms. A warning is issued, in particular, when the laser scanner 17 identifies an obstacle protruding particularly high from the crop, for example a power pole, and it is not possible to raise the at least two cantilever arms 3a, 3b by this height. The driver is alerted by the warning of the imminent obstacle and is thus in a position to initiate a braking process in due time or to evade the obstacle, if necessary. An active braking by the machine or an active evasion by the machine would also be conceivable.

If the obstacle is a well casing, for example, the device 1, in particular the at least two cantilever arms 3a, 3b, is raised by the height of the obstacle. When regulating the field sprayer across the well casing, the speed of the vehicle can be influenced at the same time without having to interrupt the entire work process of the field sprayer. A driving speed that is reduced allows for the field sprayer to be securely raised by the height of the obstacle lying ahead. Imminent collisions with obstacles can be prevented due to such a regulating of the field sprayer. The driving speed of the carrier vehicle can be reduced by approximately 30%, for example, or also by up to 60%, with these speed reductions being in particular based on the initial speed as well as on the type of obstacle, as the case may be. When the initial speed is higher, a greater reduction of the driving speed is expedient while regulating the collision prevention, whereas when the driving speed is slower, a lower speed reduction of less than 30%, as the case may be, can be expedient.

The defined pivoting of the at least two cantilever arms 3a, 3b is based on a control and a reconciliation of at least two control systems. The at least two control systems are composed of the control loop of the laser scanner 17 and of the control loop of the first sensors 9a, 9b, in particular of the ultrasonic sensors 10. The laser scanner 17 detects the crop ahead of the vehicle whereas the ultrasonic sensors 10a, 10b measure the spacing between boom linkage and crop, or, as the case may be, between the at least two cantilever arms 3a, 3b and the crop. The theoretical spacing between device 1 and crop can thus be determined from the detected crop outline and the present position of the device 1. If these two values deviate from one another, the difference between these values has to be reconciled.

As already mentioned above, the measured values of the first sensors 9a, 9b or, as the case may be, of the ultrasonic sensors 10a, 10b, serve merely for monitoring purposes and can be overridden or ignored in the present invention. The measured values from the ultrasonic sensors 10a, 10b are overridden, in particular, when there is a crop gap in the range of the ultrasonic sensors 10a, 10b. The surface model now represents the relevant parameter. The driver no longer has to actively intervene; instead, the device 1 is automatically controlled across this area.

The invention has been described with reference to a preferred embodiment. Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

1. A device for spreading liquid fertilizers, comprising:
at least two cantilever arms, wherein each arm comprises a plurality of sprayers for distributing the liquid, and wherein each arm is pivotable about one or more axes running approximately parallel to a driving direction of the device;
one or more actuators connected to the at least two cantilever arms wherein each actuator transmits an actuating force to impart a pivoting movement to the at least two cantilever arms;
one or more first sensors, wherein each first sensor measures a relative actual spacing of the at least two cantilever arms to a ground-side crop to be treated or measures a relative tilt position of the at least two cantilever arms in relation to horizontal or measures the relative actual spacing and the relative tilt position; and
one or more second sensors, wherein each second sensor detects an environmental profile preceding a driving direction of the device;
wherein the one or more first sensors and the one or more second sensors are connected to a control apparatus which controls the one or more actuators to achieve a defined pivoting movement of the at least two cantilever arms based on the actual spacing, the relative tilt position, the environmental profile, or combinations thereof; and
one or more scanners, wherein each scanner scans a surrounding area preceding the driving direction of the device and generates a surface model based on data detected by the scan, and wherein the one or more scanners are connected to a control apparatus which commands the at least two cantilever arms to a preset position based on the surface model, and wherein a control signal of the one or more first sensors is overridable by the control apparatus.

2. The device as recited in claim 1 wherein the one or more first sensors comprise at least one ultrasonic sensor.

3. The device as recited in claim 1 wherein the one or more second sensors comprise at least one laser sensor.

4. The device as recited in claim 1 in which the one or more second sensors are arranged directly on one or more of the at least two cantilever arms.

5. The device as recited in claim 1 in which the one or more actuators comprise one or more hydraulic cylinders.

6. The device as recited in claim 1 wherein the one or more scanners are positioned on the roof of a self-propelled vehicle or of an agricultural towing vehicle.

7. The device as recited in claim 1 wherein the one or more scanners comprise at least one laser scanner.

8. A method for controlling the movement of at least two cantilever arms of an agricultural field sprayer, the method comprising:
scanning and detecting a surrounding across a working width of the field sprayer and in a direction preceding a driving direction of the field sprayer using one or more scanner units;
generating a surface model based on data detected by the one or more scanner units;
presetting the field sprayer based on the generated surface model;
pivoting in a defined manner of the at least two cantilever arms based on the detected surrounding preceding the field sprayer; and
monitoring the defined pivoting of the at least two cantilever arms by determining a relative actual spacing of the at least two cantilever arms to a ground-side crop to be treated, determining a relative tilt position of the at least two cantilever arms in relation to a horizontal, or combinations thereof, and by detecting an environmental profile preceding the field sprayer in a driving direction.

9. The method as recited in claim 8 in which the defined pivoting of the at least two cantilever arms is overridden based on the generated surface model.

10. The method as recited in claim 8 wherein the environmental profile preceding the field sprayer in a driving direction is detected by at least one laser sensor.

11. The method as recited in claim 10 wherein a transmitter of the at least one laser sensor emits an at least approximately horizontally oriented laser beam.

12. The method as recited in claim 8 in which the relative actual spacing of the at least two cantilever arms to the ground-side crop to be treated is determined by way of a plurality of ultrasonic sensors arranged on the at least two cantilever arms.

13. The method as recited in claim 8 wherein the defined pivoting of the at least two cantilever arms is effected by one or more hydraulic actuators.

14. The method as recited in claim 8 wherein the surrounding is detected across an entire working width of the field sprayer by at least one laser scanner.

15. The method as recited in claim 14 wherein the surrounding is detected by means of the laser scanner to distances of approximately 20 meters to the, left approximately 20 meters to the right, and approximately 15 meters to the front of the field sprayer.

16. The method as recited in claim 8 wherein a terrain relief, comprising driving lanes or irregularities, is mapped by the surface model.

17. The method as recited in claim 8 wherein the surface model is output to a monitor.

18. The method as recited in claim 8 in further comprising issuing a warning to the monitor based on the surface model.

19. The method as recited in claim 8 in which a driving speed of the field sprayer or a carrier vehicle for the field sprayer is reduced based on the surrounding preceding the field sprayer in driving direction during or in preparation of a defined pivoting process or in preparation of the pivoting process of at least one of the at least two cantilever arms (3a, 3b).
